(19) United States
(12) Patent Application Publication
(10) Pub. No.: US 2011/0226963 A1
(43) Pub. Date: Sep. 22, 2011

(54) METHOD AND APPARATUS FOR PERFORMING MULTIPOINT FCS

(75) Inventor: Werner Knebel, Kronau (DE)

(73) Assignee: LEICA MICROSYSTEMS CMS GMBH, Wetzlar (DE)

(21) Appl. No.: 13/048,068

(22) Filed: Mar. 15, 2011

(30) Foreign Application Priority Data
Mar. 16, 2010 (DE) 10 2010 015 982.4
May 6, 2010 (DE) 10 2010 016 818.1

(51) Int. Cl. G01J 1/58

(52) U.S. Cl. 250/459.1; 250/458.1; 250/200

(57) ABSTRACT

A method of performing fluorescence correlation spectroscopy with a fluorescence microscope includes selecting an illumination area of a sample, generating an illumination light beam and splitting the illumination light beam into at least three partial beams. The partial light beams are focused onto the selected illumination area using a microscope optical system of the fluorescence microscope so as to excite fluorescent dye particles in the illumination area to fluoresce. Fluorescent light emitted by the dye particles is detected and at least one diffusion coefficient representative of a diffusibility of the fluorescent dye particles is determined based on the detected fluorescent light.

### CROSS REFERENCE TO RELATED APPLICATIONS

This application claims priority to German Patent Application No. DE 10 2010 015 982.4, filed Mar. 16, 2010 and German Patent Application No. DE 10 2010 016 818.1, filed May 6, 2010, both of which are incorporated by reference herein in their entireties.

### FIELD

The invention relates to a method for performing fluorescence correlation spectroscopy with a fluorescence microscope and an apparatus for performing fluorescence correlation spectroscopy including a fluorescence microscope.

### BACKGROUND

Fluorescence correlation spectroscopy (FCS) is an optical measuring method with which diffusion coefficients and concentrations of sample molecules of a sample and interactions between the sample molecules are measured (see “Two-Focus Fluorescence Correlation Spectroscopy”, doctoral thesis of Thomas Dertinger at the University of Cologne, 2007). For this, fluorescent dyes are introduced into the sample such that the dye particles enter into combination with the sample molecules. In particular, by fusion with proteins of a cell of the sample, fluorescent proteins can mark these proteins of the cell. For creating such fusion proteins, the DNA of the protein to be examined is combined with the DNA of the fluorescent protein and is brought into a form that can be taken up by the cell so that the cell creates the fusion protein on its own. In many application cases, the protein to be examined is still transported to the correct place in the cell. With the aid of fluorescence microscopy, the fluorescent protein can provide information on the temporal and spatial localization of the target protein in the cell. GFP, PA-GFP, Kaede, Kindling, Dronpa or PS-CFP are given as examples of fluorescent proteins.

As a result of the fluorescence of the fluorescent protein, the spatial and temporal distribution of the other protein can be directly observed in living cells, tissues or organisms. This enables the determination of the diffusion coefficient of the fluorescent dye particles and thus the diffusibility of the proteins and sample molecules bound to the fluorescent dye particles. In addition, it is possible to determine the concentration of the sample molecules bound to the fluorescent dye particles. On the basis of the diffusion coefficients it can then be checked whether the sample molecules interact with one another since, in the case of an interaction, the diffusibility of the sample molecules decreases. Similar microscopy methods in which a scanning microscope is used for determining diffusion coefficients are, for example, ICS or RICS.

### SUMMARY

In an embodiment, the present invention provides a method of performing fluorescence correlation spectroscopy with a fluorescence microscope including selecting an illumination area of a sample, generating an illumination light beam and splitting the illumination light beam into at least three partial beams. The partial light beams are focused onto the selected illumination area using a microscope optical system of the fluorescence microscope so as to excite fluorescent dye particles in the illumination area to fluoresce. Fluorescent light emitted by the dye particles is detected and at least one diffusion coefficient representative of a diffusibility of the fluorescent dye particles is determined based on the detected fluorescent light.

In another embodiment, the present invention provides an apparatus

### BRIEF DESCRIPTION OF THE DRAWINGS

Exemplary embodiments of the present invention are described in more detail below with reference to the schematic depictions shown in the drawings, in which:

FIG. 1 shows an embodiment of a fluorescence microscope;

FIG. 2 shows an illustration of a sample;

FIG. 3 shows a first minor device;

FIG. 4 shows an embodiment of a sample holder with the sample;

FIG. 5 shows a detector device;

FIG. 6 shows a flow diagram of a program for performing multipoint FCS;

FIG. 7 shows another embodiment of the sample holder with the sample;

FIG. 8 shows a flow diagram of a program for adjusting a confocality of the fluorescence microscope; and

FIG. 9 shows another embodiment of the fluorescence microscope.

### DETAILED DESCRIPTION

In an embodiment, the present invention provides a method and an apparatus for performing fluorescence correlation spectroscopy, which enable in an easy and flexible manner an examination of a sample, in particular a determination of diffusion coefficients of sample molecules of the sample.

In an embodiment, the present invention provides a method for performing fluorescence correlation spectroscopy with a fluorescence microscope. Here, an illumination light beam is generated and at least one illumination area of the sample is selected. The illumination light beam is split into at least three partial beams such that the partial beams are focused via a microscope optical system of the fluorescence microscope onto the selected illumination area, as a result whereof dye particles in the illumination area of the sample are excited to fluoresce. The fluorescent light emitted by the dye particles is detected and, depending on the detected fluorescent light, at least one diffusion coefficient is determined which is representative of a diffusibility of the fluorescent dye particles.

The selection of the illumination area or the illumination areas, which may be shaped fully arbitrarily and the number of which may be chosen arbitrarily, enables in an easy manner a particularly flexible examination of the sample. In particular, diffusion coefficients of equal or different dye particles and thus of equal or different sample molecules can be simultaneously determined in the different illumination areas and can be compared to one another. The determination of the diffusion coefficients enables to obtain detailed information on whether and, if so, which sample molecules interact with one another since, in the case of interactions, the diffusion coefficients of the involved sample molecules decrease. The sample molecules also comprise proteins in the sample.

The illumination of the illumination area or the illumination areas of the sample with the aid of at least three partial beams very efficiently helps in being able to arbitrarily select and, at the same time, advantageously illuminate the illumination areas. The inventive method can also be referred to as multipoint FCS, which expresses that the method is a fluorescence correlation spectroscopy with several, in particular at least three illumination foci.

In an embodiment, at first an image of the sample is taken and displayed on a display unit. On the basis of this image, a user selects at least one arbitrary or predetermined partial area of the image. Depending on the partial area or the partial areas selected, it is determined how the illumination light beam has to be split so that the partial beams of the illumination light beam are focused onto illumination areas of the sample that correspond to the partial areas of the image of the sample. Subsequently, the illumination light beam is split accordingly, and the sample is illuminated accordingly. The selection of arbitrary partial areas on the basis of the image of the sample makes a particularly intuitive and flexible examination of the sample possible.

The fluorescent light is directed onto a detector device comprising several detector elements. On a sensitive area of the detector device several detection foci are caused due to the fluorescent light. Depending on the selected illumination area or the selected illumination areas on or within the sample, positions of the corresponding detection foci on the sensitive area of the detector device are determined. In the following, exactly those detector elements are selectively read out and/or their signals are selectively evaluated on which the detection foci are positioned. This helps in determining the diffusion coefficients and the concentrations in a particularly efficient and particularly fast manner.

The confocality of the fluorescence microscope can easily be adjusted in that the number of the detector elements which are read out and/or evaluated per detection focus is set. This makes use of the fact that the detection foci have a light distribution which generally has its maximum in the center of the detection focus. A maximum confocality can now be achieved when merely one of the detector elements, which preferably lies in the center of the detection focus, is read out or, respectively, evaluated. With increasing number of detector elements per detection focus, then the confocality decreases. This corresponds to a pinhole diaphragm having a variable pinhole diameter. In an extreme case, all detector elements are read out and evaluated, which corresponds to a wide field shot of the sample. The wide-field shot can, for example, be used for taking the image of the sample.

In an embodiment, the present invention provides an apparatus for performing fluorescence correlation spectroscopy. The apparatus comprises the fluorescence microscope which has a light source generating the illumination light beam. The illumination light beam is directed onto a first mirror device having a large number of optical elements. A control unit is coupled to the first mirror device and controls the optical elements such that the optical elements split the illumination light beam into at least three partial beams. A microscope optical system focuses the partial beams onto the illumination areas of the sample. The partial beams excite the dye particles of the sample to fluoresce. A detector device detects the fluorescent light beams emitted by the sample. The detector device comprises several detector elements, the control unit controlling which detector elements are read out and/or evaluated.

When creating several illumination foci within one or several illumination areas, an undesired background signal may be generated due to overlapping of different illumination light cones or detection light cones. In a conventional confocal microscope with one single illumination focus, a reduction of this background signal can be achieved with the aid of a pinhole diaphragm in the detection beam path. For reducing the background signal in the case of multipoint FCS with several illumination foci, preferably a second mirror device is arranged onto which fluorescent light beams emitted by the sample are directed and via which the fluorescent light beams pass to the detector device. In accordance with the first mirror device, the second mirror device has a large number of optical elements. Preferably, the optical elements of the second mirror device are controlled in accordance with the control of the optical elements of the first mirror device. The second mirror device can be used like several pinhole diaphragms, both their number as well as their pinhole shape being variable depending on the control of the optical elements.

In the case of fluorescent samples, the emission wavelength of the fluorescent light is basically longer than the excitation wavelength. Thus, also the focus of the fluorescent light projected onto the second mirror device is larger than the corresponding illumination focus in the sample. Therefore, it may be advantageous to enlarge the pinhole diaphragm size in front of the detector device to not lose any light. The enlargement of the pinhole diaphragm can be achieved for the second mirror device in that one activates still further optical elements of the second mirror device around those active optical elements of the second mirror device that correspond to the active optical elements of the first mirror device. If one wishes to obtain a low confocality, correspondingly more optical elements of the second mirror device can be activated.

Alternatively, the fluorescent light emitted by the sample can be guided via the first mirror device to the detector device, however the pinhole diaphragm size can then no longer be varied as with the aid of the first mirror device also the partial beams of the excitation light are generated.

Elements having the same structure or function are identified with the same reference signs throughout all Figures.

FIG. 1 shows a fluorescence microscope 20 that comprises a light source 22 which generates an illumination light beam 24. A first beam splitter 28 directs the illumination light beam 24 to a first mirror device 26. The first mirror device 26 directs partial beams 30 of the illumination light beam 24 to the first beam splitter 28 that allows the partial beams 30 to pass through to a first lens system 32. The first lens system 32 images the partial beams 30 onto a second beam splitter 34 that deflects the partial beams 30 to an objective 36. The objective 36 focuses the partial beams 30 onto or into a sample 40 held by a sample holder 38. Each focused partial beam 30 causes one illumination focus 42 each on or within the sample 40. The other portions of the illumination light beam 24 apart from the partial beams 30 are compensated by the first mirror device 26 or are deflected such that they are not guided further to the sample 40.

The sample 40 comprises dye particles which are coupled to sample molecules, for example proteins, of the sample 40 and which can be excited to fluoresce. The dye particles can be excited to fluoresce and comprise, for example, fluorescent proteins, such as GFP, PA-GFP, Kaede, Kindling, Dronpa, PS-CFP or many others. The dye particles which are located in the illumination foci 42 emit fluorescent light 44 which is directed via the objective 36 and the beam splitter 34 onto a second lens system 46. The second lens system 46 images the fluorescent light 44 onto a third beam splitter 47 that splits the fluorescent light 44 into a first detection partial beam 48 and a second detection partial beam 54 and that allows the first detection partial beam 48 to pass through to a first detector device 52 via a first barrier filter 50 and that reflects the second detection partial beam 54 via a second barrier filter 56 to a second detector device 58.

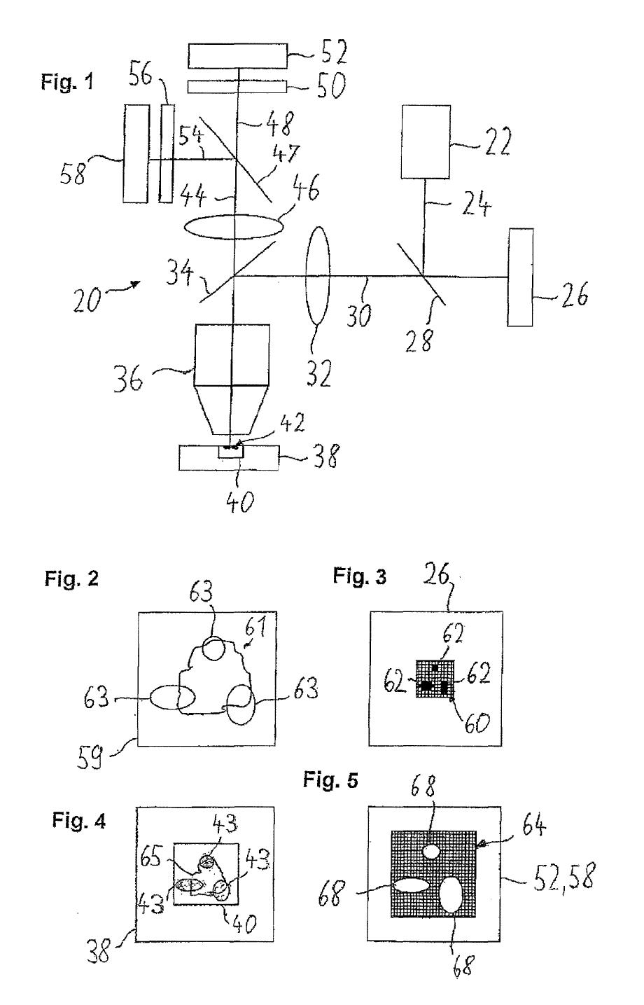

FIG. 2 shows a display unit 59, for example a screen, on which an image 61 of the sample 40 is illustrated. On the display unit 59, partial areas 63 of the display unit 59 are identified. The partial areas 63 are arbitrarily selected by a user. That means that the user can select with the aid of a user input into a non-illustrated selection device the number and the shape of the partial areas 63 arbitrarily or in an arbitrarily predefined manner. In particular, the user selects at least one partial area 63. The selection device is, for example, comprised by a computer and has an input device which is coupled to an arithmetic unit, for example, a mouse or a digital computer pen, the arithmetic unit being coupled to the display unit 59. Thus, the user can individually and flexibly set which area or which areas of the sample 40 are to be examined. For example, the user can select the partial areas 63 such that changes in the diffusibility of individual dye particles and of the sample molecules with which they are combined can be observed at the crossing from one sample structure to another sample structure, for example, in the case of diffusion through a cell membrane of the sample. The change in diffusibility of the sample molecules can be a proof of interactions of the sample molecules with one another since their diffusibility decreases in the case of an interaction.

FIG. 3 shows the first mirror device 26 which comprises a large number of optical elements 60. The first mirror device 26 comprises a micromirror actuator which comprises single movable mirrors as optical elements 60. The optical elements 60 comprise several active optical elements 62 which are identified in FIG. 3 as blackened areas. The active optical elements 62 are characterized in that they reflect at least three, preferably more partial beams 30 of the illumination light beam 24 such that the partial beams 30 are directed onto the sample 40 via the first lens system 32 and the objective 36. The other optical elements 60 are set such, in particular the movable mirrors are tilted such that the partial beams 30 reflected in this way are not focused onto the sample 40 via the objective 36 or that these portions of the illumination light beam 24 are not reflected at all by the respective mirrors but are rather absorbed. The first mirror device 26 preferably comprises a micromirror array (digital minor device) with individual controllable movable mirrors. Alternatively, the first mirror device can comprise an LCOS actuator with several LCOS chips (liquid crystal on silicon), wherein the LCOSs in the first switching state allow light to pass through to a mirrored area behind the corresponding LCOSs and back, and the LCOSs in the second switching state do not allow light to pass through to the mirrored area behind the corresponding LCOSs. For example, the LCOSs can be used as polarization filters and the illumination light can be generated in such a polarized manner or can be polarized with the aid of the first beam splitter 28 such that then, depending on the switching state of the LCOSs, the illumination light is selectively absorbed and not reflected or reflected.

FIG. 4 shows the sample holder 38 as viewed from the objective 36. The sample holder 38 holds the sample 40 which has a sample structure 65. The sample structure 65 comprises, for example, a cell membrane or a nuclear membrane of a nucleus of the sample 40. Illumination areas 43 on the sample 40 correspond to the selected partial areas 63 on the display unit 59. The illumination areas 43 are illuminated with several illumination foci 42 which are caused by the partial beams 30 that are directed from the active optical elements 62 to the sample 40. The individual illumination foci 42 of which the illumination areas 43 are composed are not illustrated in FIG. 4 for reasons of clarity. Alternatively, the illumination areas 43 can also be selected so small that they can be illuminated with only one illumination focus 42.

FIG. 5 shows a surface of the detector devices 52, 58. The respective detector device 52, 58 has on its surface a sensitive area formed by a large number of detector elements 64. The detection partial beams 48, 54 are directed onto the sensitive area of the detector devices 52, 58 such that several detection foci are caused in one detection area 68 each on the sensitive area. The detection foci correspond to the illumination foci 42 on the sample 40 and to the active optical elements 62 of the first mirror device 26, and the illuminated detection areas 68 correspond to the illumination areas 43 on the sample 40 and to the partial areas 63 on the display unit 59. The detector elements 64 are preferably CMOS detectors or, in the alternative, ADPs or DEPFET detectors.

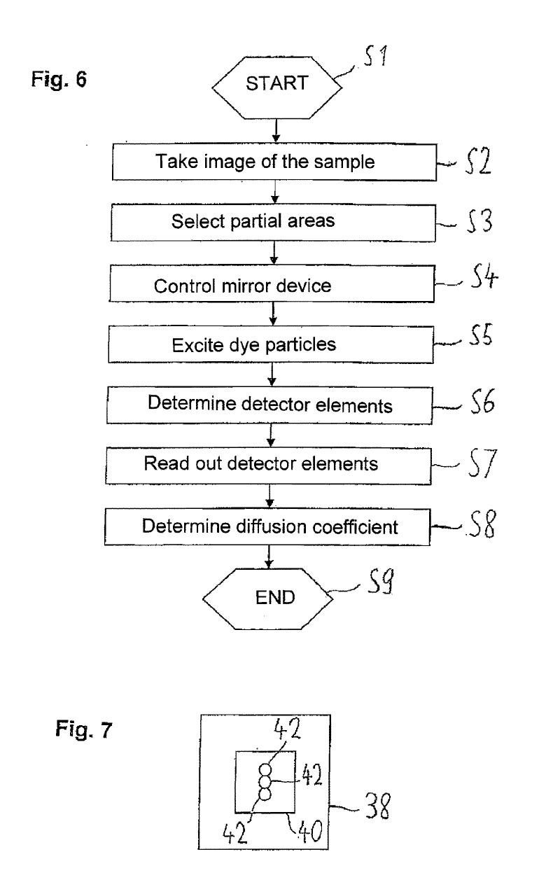

FIG. 6 shows a flow diagram of a program for performing multipoint FCS with the fluorescence microscope 20. In the known fluorescence correlation spectroscopy (FCS) diffusion coefficients of individual sample molecules are determined with the aid of one or two illumination foci 42. In multipoint FCS, diffusion coefficients of individual sample molecules are determined with the aid of three or more illumination foci 42, wherein the illumination foci 42 are directed onto the illumination areas 43 of the sample 40 and illuminate these. Depending on the diffusion coefficients, then the concentration of the sample molecules can be determined and interactions between the sample molecules can be proved. The program serves to determine at least the diffusion coefficient of one type of sample molecules of the sample 40. The program is preferably started in a step S1, for example, immediately after the switching-on of the fluorescence microscope 20.

In a step S2, the image 61 of the sample 40 is taken. The image 61 can, for example, be taken with the aid of the wide-field shot, in which all optical elements 60 of the first mirror device 26 are active and thus, almost the entire illumination light beam 24 is directed to the sample 40 and in which all detector elements 64 of the two detector devices 52, 58 are read out and evaluated.

In a step S3, a user of the fluorescence microscope 20 selects one or several partial areas 63 on the display unit 59 with the aid of the selection device on the basis of the image 61 of the sample 40, wherein both the number and the shape of the partial areas 63 can be arbitrarily selected by the user.

Depending on the partial areas 63 on the display unit 59 predetermined by the user, the first mirror device 26 is controlled in a step S4 with the aid of the control unit such that exactly those optical elements 60 of the first mirror device 26 are activated which split the illumination light beam 24 such and reflect the corresponding partial beams 30 such that these partial beams 30 cause illumination foci 42 on the sample 40 such that the illumination areas 43 of the sample 40 corresponding to the partial areas 63 are illuminated.

In a step S5, the dye particles in the illumination foci 42 are excited to fluoresce. If dye particles are used that have a first state in which the dye particles can be excited to fluoresce, and that have a second state in which the dye particles cannot be excited to fluoresce, then, prior to the step S5, a subset of the dye particles in the first state is generated. Known microscopy methods which make use thereof are, for example, PALM, STORM, FPALM, DSTORM, GSDIM and others. Known dye particles which are used here are, for example, PA-GFP, PS-CFP etc.

In a step S6, those detector elements 64 onto which the detection partial beams 48, 54 are focused in the form of the detection foci are determined depending on the selected partial areas 63.

In a step S7, the detector elements 64 determined in step S6, are read out and their data are evaluated. Alternatively, all detector elements 64 can be read out but only the data of those detector elements 64 determined in step S6 are evaluated. This selective read-out and/or evaluation of the detection areas 68 helps in determining the diffusion coefficients in a particularly fast manner.

Depending on the evaluated data, at least one diffusion coefficient of sample molecules of the sample 40 is determined. Alternatively or additionally, the sample molecule concentration of individual sample molecules in the selected partial areas 63 can be determined. On the basis of the diffusion coefficients, interactions of the sample molecules with one another can be observed since usually the diffusibility of the sample molecules decreases as soon as these interact with other sample molecules.

In a step S9, the program can be terminated. Preferably, the program is however executed continuously during the operation of the fluorescence microscope 20, in particular whenever the user selects new partial areas 63 on the basis of the display of the image 61 on the display unit 59.

FIG. 7 shows an embodiment in which the illumination foci 42 are arranged adjacent to one another such that moving sample molecules in the sample 40 can be observed over a longer distance. The creation of several illumination foci 42 arranged adjacent to one another makes it very well possible to examine neighborhood relations of the sample molecules relative to one another.

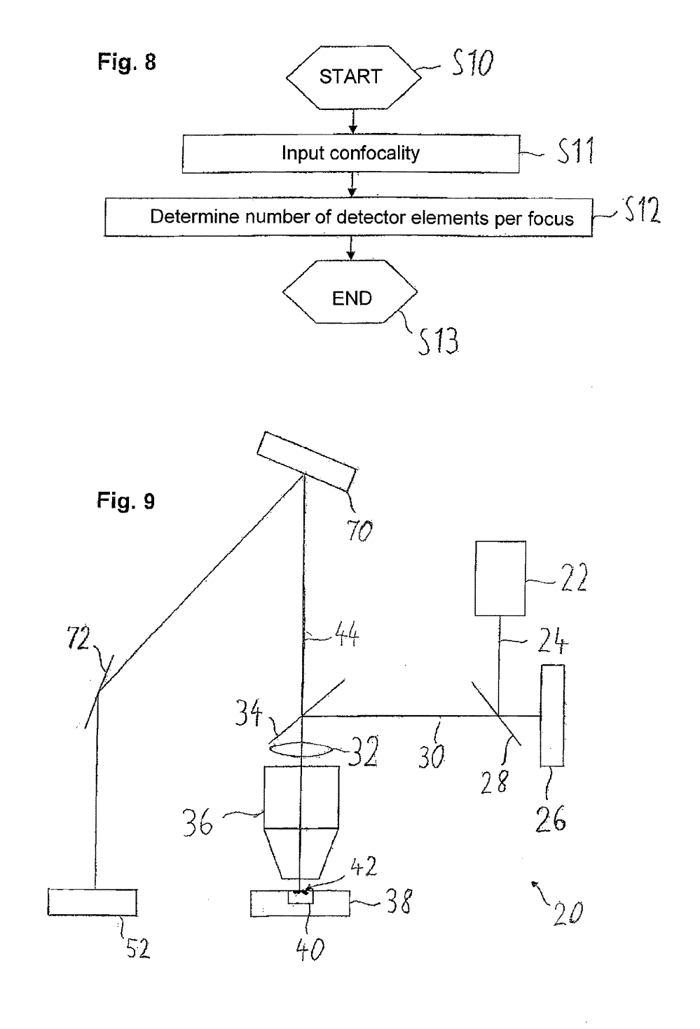

FIG. 8 shows a flow diagram of a program for adjusting a confocality of the fluorescence microscope 20. The program is preferably started in a step S10, in which, if necessary, variables are initialized. In a step S11, the desired confocality is predetermined by the user. Depending on the input confocality, in a step S12 the number of the detector elements 64 is determined which are read out or evaluated per illumination focus 42 and corresponding detection focus. The higher the confocality, the less detector elements 64 per detection focus are read out. The lower the confocality is predetermined, the more detector elements 64 per detection focus can be read out. In a step S13, the program can be terminated. Preferably, however, after the step S13, the program for performing multipoint FCS is executed.

Due to the several illumination foci 42 within one or several of the illumination areas 43, there may occur optical crosstalk, in particular an overlapping of several illumination light cones or detection light cones. This results in stray light and an undesired background signal which, with increasing sample thickness, becomes stronger.

FIG. 9 shows an embodiment of the fluorescence microscope 20 in which the fluorescent light beams 44 hit a second mirror device 70 prior to detection, which second mirror device serves to reduce and/or prevent the undesired background signal. The second mirror device 70 can be designed in accordance with the first mirror device 26 and can have a micromirror actuator, in particular several controllable optical elements. The optical elements of the second mirror device 70 are active or passive depending on their switching state. The active optical elements of the second mirror device 70 direct the fluorescent light beams 44 directed thereon via a mirror 72 to the first detector device 52. The spatial arrangement and orientation of the second mirror device 70 is precisely adapted to the spatial arrangement and orientation of the first mirror device 26. As the two mirror devices 26, 70 are located in planes conjugated to the sample 40, it is important that the optical path from the first mirror device 26 to the sample corresponds to the optical path from the sample 40 to the second mirror device 70. Therefore, in this embodiment, the first lens system 32 is arranged between the second beam splitter 34 and the objective 36 so that both the illumination light and the detection light pass through the first lens system 32. Further, the distance from the sample 40 to the first mirror device 26 should be as long as the distance from the sample 40 to the second mirror device 70.

The second mirror device 70 is preferably coupled to the control unit that controls the optical elements of the second mirror device 70 in accordance with the optical elements 60 of the first mirror device 26. This means that a pattern represented by the active optical elements on the second mirror device 70 exactly corresponds to the pattern represented by the active optical elements 62 on the first mirror device 26. When the optical elements 60 of the first mirror device 26 are switched, then, accordingly, also a switching of the optical elements of the second mirror device 70 takes place.

The functioning of the second mirror device 70 corresponds to the one of a variable pinhole diaphragm, wherein with the aid of the optical elements of the second mirror device 70 both the position and the shape as well as the number of the pinhole diaphragms can be varied. Preferably, the optical elements 60 of the first mirror device 26 are connected in parallel to the optical elements of the second mirror device 70 and thus time-synchronized with these. Thus, for each partial light beam 30 and each corresponding fluorescent light beam 44 an own pinhole diaphragm can be created in that the corresponding optical elements of the second mirror device 70 are activated. As a result thereof, less stray light reaches the first detector device 52 than without the second mirror device 70.

Preferably, around the active optical elements of the second mirror device 70 which correspond to the active optical elements of the first mirror device 26, further optical elements of the second mirror device 70 are activated since in the case of fluorescent samples 40 the emission wavelength is usually longer than the excitation wavelength, as a result whereof also the focus of the fluorescent light 44 projected onto the second mirror device 70 is larger than the illumination focus 42. This corresponds to an enlargement of the pinhole diaphragm and helps in losing as little fluorescent light 44 as possible. If one wishes to achieve a low confocality, correspondingly more optical elements of the second mirror device 70 can be activated.

In the case of FCS measurements it is also advantageous if one can set different detection volumina in order to obtain better information on the diffusion speed, this can be determined via the size of the pinhole diaphragms in front of the detection device 52.

The invention is not restricted to the embodiments as specified. For example, more or less detector devices 52, 58 can be arranged. Further, more or less lens systems 32, 46 can be arranged. Further, the light source 22 can comprise one or several lasers that generate illumination light of different wavelength. This enables that different dye particles are excited to fluoresce and thus that different sample molecules are observed at the same time. When illuminating the illumination areas 43, the distances between the illumination foci to one another can be varied in that within the illumination areas 43 individual possible illumination foci 42 are not created and are thus omitted. The illumination light beam can comprise light of different wavelengths so that at the same time dye particles of different color can be excited to fluoresce, as a result whereof at the same time several different types of sample molecules can be observed and their diffusion coefficients can be simultaneously determined. In this embodiment of the fluorescence microscope 20, the second detector device 58 can likewise be arranged. Further, the fluorescence microscope 20 can comprise by far more optical components, for example lenses. In particular, lenses can be arranged between the light source 22 and the first beam splitter 28 and/or between the second mirror device 70 and the first detector device 52. Alternatively to the second mirror device 70, the fluorescent light 44 can also be guided via the first mirror device 26 to the detector device 52, then a variation of the pinhole diaphragm size no longer being possible since the partial beams 30 are generated with the aid of the first mirror device 26.

While the invention has been particularly shown and described with reference to preferred embodiments thereof, it will be understood by those skilled in the art that various changes in form and details may be made therein without departing from the spirit and scope of the invention.

### LIST OF REFERENCE SIGNS

20 fluorescence microscope
22 light source
24 illumination light beam
26 first mirror device
28 first beam splitter
30 partial beams
32 first lens system
34 second beam splitter
36 objective
38 sample holder
40 sample
42 illumination focus
43 illumination area
44 fluorescent light
46 second lens system
47 third beam splitter
48 first detection partial beam
50 first barrier filter
52 first detector device
54 second detection partial beam
56 second barrier filter
58 second detector device
59 display unit
60 optical elements
61 image
62 active optical elements
63 partial areas
64 detector elements
65 sample structure
68 detection area
70 second mirror device
72 minor
S1-S13 steps one to thirteen

What is claimed is:

1: A method of performing fluorescence correlation spectroscopy with a fluorescence microscope, the method comprising:
selecting at least one illumination area of a sample;
generating an illumination light beam;
splitting the illumination light beam into at least three partial beams;
focusing the at least three partial beams onto the selected illumination area using a microscope optical system of the fluorescence microscope so as to excite fluorescent dye particles in the illumination area to fluoresce;
detecting fluorescent light emitted by the dye particles; and
determining at least one diffusion coefficient representative of a diffusibility of respective fluorescent dye particles based on the detected fluorescent light.

2: The method recited in claim 1, further comprising:
displaying an image of sample on a display device;
selecting a partial area of the image of the sample; and
determining the splitting of the illumination beam so as to enable the focusing; and wherein the selecting the at least one illumination area of the sample is performed based on the selected partial area and the at least one illumination area of the sample corresponds to the selected partial area.

3: The method recited in claim 1, further comprising, based on the at least one diffusion coefficient, determining an interaction between sample molecules coupled to the dye particles corresponding to the determined at least one diffusion coefficient.

4: The method recited in claim 1, wherein the detecting the fluorescent light includes:
directing the fluorescent light onto a sensitive area of a detector device including a plurality of detector elements and forming at least three detection foci corresponding to the at least three partial beams focused onto the illumination area of the sample,
and further comprising determining positions of the at least three detection foci on the sensitive area of the detector device based on the illumination area of the sample, and at least one of: selectively reading out only the detector elements corresponding to the positions of the detection foci, and selectively evaluating signals of the detector elements corresponding to the positions of the detection foci.

5: The method recited in claim 4, further comprising adjusting a confocality of the fluorescence microscope to more than one focus, and setting a number of detector elements which are at least one of read out and evaluated for each focus.

6: The method recited in claim 1, wherein the dye particles have a first state in which the dye particles are excitable so as to fluoresce and a second state in which the dye particles cannot be excited to fluoresce, further comprising generating a subset of the dye particles in the first state and exciting the subset of dye particles.

7: The method recited in claim 1, wherein each partial beam defines an illumination area of the sample, and wherein at least two of the illumination areas are adjacent, further comprising observing a movement of a single dye particle across more than one of the illumination areas and determining a diffusion coefficient of the single dye particle.

8: The method recited in claim 1, wherein the generating the illumination light beam includes pulsing the illumination light beam, further comprising:
at least one of reading out and evaluating detector elements based on pulses of the illumination light beam;
determining luminous lifetimes of the dye particles based on the detected fluorescent light; and
examining at least one of combinations and interactions of sample molecules coupled to the respective dye particles based on the determined luminous lifetimes.

9: An apparatus for performing fluorescence correlation spectroscopy, the apparatus including a microscope comprising:
a light source configured to generate an illumination light beam;
a first mirror device including a plurality of optical elements and configured to receive the illumination light beam;
a control unit coupled to the first minor device and configured to control the plurality of optical elements so as to split the illumination light beam into at least three partial beams;
a microscope optical system configured to focus the at least three partial beams of the illumination light beam onto at least one illumination area of a sample so as to excite dye particles to fluoresce; and
a detector device including a plurality of detector elements and configured to detect fluorescent light beams emitted by the sample, the control unit being configured to control a selection of the detector elements to be at least one of read and evaluated.

10: The apparatus recited in claim 9, further comprising a display unit configured to display an image of the sample and a selection device configured to select at least one partial area of the image based on a user input, wherein the control unit is configured to control the plurality of optical elements so as to direct the partial beams to positions corresponding to the at least one partial area.

11: The device recited in claim 9, wherein the control unit is configured to at least one of read out and evaluate the detector elements receiving the fluorescent light beams emitted by the sample.

12: The device recited in claim 9, wherein the microscope is configured to set a confocality based on a number of the detectors that is at least one of read out and evaluated for each detection focus.

13: The device recited in claim 9, wherein the first minor device includes a micromirror actuator and the plurality of optical elements include movable mirrors.

14: The device recited in claim 9, wherein the first minor device includes an LCOS actuator and the plurality of optical elements each include one polarization element and one micromirror.

15: The device recited in claim 9, wherein the plurality of detector elements include at least one of a CMOS detector, an APD detector, a fully-depleted silicon detector and a DEPFET detector.

16: The device recited in claim 9, further comprising a second mirror device including a plurality of other optical elements and configured to direct the fluorescent light beams emitted by the sample to at least one of the first detector device and a second detector device.

17: The device recited in claim 16, wherein the second mirror device is coupled to the control unit, and wherein the control unit is configured to control the other optical elements in accordance with the plurality of optical elements of the first mirror device.
